(19) United States
(12) Patent Application Publication
(10) Pub. No.: US 2013/0283325 A1
(43) Pub. Date: Oct. 24, 2013

(54) Entertainment System and Method for Displaying Multimedia Content

(71) Applicant: Paul Chiniara, Brossard (CA)

(72) Inventor: Paul Chiniara, Brossard (CA)

(21) Appl. No.: 13/868,634

(22) Filed: Apr. 23, 2013

Related U.S. Application Data
(60) Provisional application No. 61/636,847, filed on Apr. 23, 2012.

(51) Int. Cl. H04N 21/478

(52) U.S. Cl. CPC H04N 21/478
USPC 725/83; 725/78

(57) ABSTRACT

A novel entertainment system and method for multimedia presentation will be described hereinafter. The novel entertainment system generally comprises a display and sound system in connection with a server. The system allows clients users or patrons to configure the ambiance of the room through the use of a remote controller. The server may be integrated within a TV or a projector, such as, but not limited to a “Smart” TV wherein the TV has computing abilities. The TV may further be connected to a network.

Accordingly, the user will generally be able to control the content displayed on the screen in order to create an individualized user experience.

### CROSS-REFERENCE TO RELATED APPLICATIONS

The present patent application claims the benefits of priority of U.S. Provisional Patent Application No. 61/636,847, entitled “Entertainment System and Method for Displaying Multimedia Content”, and filed at the United States Patent and Trademark Office on Apr. 23, 2012, the content of which is incorporated herein by reference.

### FIELD OF THE INVENTION

The present invention generally relates to entertainment systems and methods, more specifically to entertainment systems and methods comprising a room to display multimedia content typically located in a bar or a restaurant.

### BACKGROUND OF THE INVENTION

Nowadays, all kinds of restaurants and entertainment venues are available to the public, such as, sports bar, lounge, classic ambiance restaurant, pizzeria etc. The downturn of all such specialized restaurants is the targeted clientele which is inherently variable from a sport bar to a chic sushi restaurant. A restaurant will typically aim to attract a certain kind of people as clientele. The resulting attracted clientele will generally vary depending on the client's taste and mood on the specific day where this client chooses to visits such venue. Restaurants typically install video displays such as TVs and screen projector, wherein sport events and/or video clips may be displayed. However, the content displayed is most likely chosen by the employees and typically fits into the wider theme of the venue. Also, several entertainment venues or restaurants install comprehensive audio systems wherein music or sounds may be played. Such audio systems are typically controlled by employees who select music from a limited collection. Furthermore, the volume of such audio system is typically set at a level in order to be convenient for the majority of customers.

This wide variety of venues and the associated specialized ambiance may not meet or suite the taste of every client. Furthermore, several newcomers may not be satisfied with the content played through the central audio system and/or with the video content visible from their position in the venue. There is thus a need for an entertainment venue, such as a restaurant, having the ability to meet the taste of every customer or guest, wherein every person may find the desired music and/or may choose the content to be displayed on a nearby screen.

### SUMMARY OF THE INVENTION

One of the objects of the present invention is to provide a room for one or more guests, wherein the room is simulating the ambiance of a theatre, a venue or an arena or simulating the comfort of a living room while being a guest at a restaurant or bar.

Within the present document, the terms guest, user, customer shall identifies a guest of a room comprising the disclosed entertainment system or a guest following the steps of the disclosed methods for displaying multimedia content.

Another object of the present invention is to allow a patron or user to easily navigate or control multimedia content to be display within the room. One further object is to easily integrate and implement any new or existing audio-video technology to the benefit of patrons and/or guests.

Another object of the present invention is to allow a patron or user to upload content to be watched or listened and to navigate or control multimedia content to be displayed within the room in order to create a personalized experience.

A further object of the present invention is to provide to the customer or patron a rich and unique dining and/or entertainment experience without having to disburse large amount of money.

The aforesaid and other objectives of the present invention are realized by generally providing an entertainment system and interface for displaying multimedia content.

In a preferred embodiment, one or more entertainment systems are installed within a room or suite located in a cinema and/or theatre theme restaurant and provides access to a plurality of interactive media and entertainment content or services. A user, typically a patron or customer of the restaurant, may interact with the entertainment system using an interface device having a computer program allowing the access to media. Additionally, the interface device may be programmed to act as an automated ordering system for food, beverages or any other service provided by the restaurant.

According to an aspect of the present invention, an interactive entertainment system allowing at least one user to access a plurality of interactive media and entertainment content or services within a physical room of an establishment is disclosed. The interactive entertainment system comprises a physical room having at least two walls, a ceiling and at least one element of furniture wherein each element of furniture is located within the boundaries of the physical room. The interactive entertainment system may further comprises at least one interface device allowing the at least one user to control the entertainment system, wherein the interface device has one or more input/output communication port and an inputting device. Furthermore, the entertainment system comprises at least one visual display device allowing multimedia content to be displayed and installed in the physical room, at least one audio system installed in the physical room, a server configured to process multimedia content and to communicate the multimedia content to the visual display device and/or to the audio system on reception of an input from the interface device and a network configured to interconnect the interface device with the server.

According to another aspect of the present invention, a method using an entertainment system, wherein the entertainment system comprises a physical room, at least one server, at least one interface device allowing the at least one user to control the entertainment system, a visual display device allowing multimedia content to be displayed, at least one audio system and a network configured to interconnect the at least one interface device with the at least one server is disclosed. The method comprises the steps to upload or use a personal device to receive, stream, communicate or transfer selected multimedia content through the at least one physical interface device, display the multimedia content to the visual display device, communicate the audio data to the at least one audio system and control the multimedia content playback using the at least one interface device.

According to another aspect of the present invention, a system allowing the user to configure a room in a venue or restaurant in order to fulfill the user's needs and preferences is disclosed. As such, the system allows to configure a room of a venue or restaurant in order to attract a wide range of clients. The disclosed system allows clients users or patrons to configure the ambiance of the room through the use of a remote controller and by using a display and sound system in connection with a server. The server may be located in various locations such as at elevated height in the room, near the ceiling The server could also be integrated within the TV or a projector, such as, but not limited to a “Smart” TV wherein the TV has computing abilities and wherein the TV may further be connected to the network. The user will be able to control the content displayed on the screen in order to create an individualized user experience. Such system allows the user to tune or customize the room to the specific tastes or needs of the client.

According to another aspect of the present invention, the present system could alternatively be controlled via a smart phone capable of executing an application, such as an application downloaded via the restaurant's web site or via one or more application store. As an example, a client reserving at the restaurant may be redirected to a website or an application store allowing the download and installation of an application for a smart phone or a tablet allowing the control or display of the digital content on the display system within a restaurant room. Accordingly, such embodiment may limit the usage of a standard remote controller. As such, the use of an application for smart phone or tablet would significantly reduce the cost associated with the procurement of an interface device such as remote controllers. In such an embodiment, the restaurant may limit the quantity of interface devices to be used by client no using a smart phone.

According to another aspect of the present invention, an application based interface device would improve the client learning curve and interaction with the system. As such, a client planning to visit the restaurant may download the application prior to the visit and get used to the functioning of the application interface thereby improving the dining and/or entertainment experience. Accordingly, the client familiarity with the application based interface would mitigate the needs to learn interfaces while in the restaurant.

According to another aspect of the present invention, the present system will allow a restaurant to customize the ambiance to a wide variety of audience. As such it will allow restaurants, to instantly personalize a specific room to a desired public or audience. In addition, the system in accordance with an aspect of the present invention will have the ability to allow the user to display any content of his choice.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a perspective view of a novel entertainment system for multimedia presentation in accordance with the present invention.

FIG. 2 is a top view configuration of a novel entertainment system for multimedia presentation in accordance with the present invention.

FIG. 3 is a menu interface for an interface device used in with a novel entertainment system for multimedia presentation in accordance with the present invention.

FIG. 4 is a scheme of the entertainment system in accordance with the present invention, illustrating the components and how they may interact.

FIG. 5 is a scheme of an entertainment system in accordance with the present invention illustrating how the user may interact with the said system.

FIG. 6 is a top view of a remote controller capable of interacting with an entertainment system in accordance with the present invention.

### DETAILED DESCRIPTION OF THE PREFERRED EMBODIMENT

A novel entertainment system and method for multimedia presentation will be described hereinafter. Although the invention is described in terms of specific illustrative embodiment(s), it is to be understood that the embodiment(s) described herein are by way of example only and that the scope of the invention is not intended to be limited thereby.

In a preferred embodiment, one or more entertainment system is embodied as a room or suite within a cinema and/or theatre theme restaurant and provides access to a plurality of interactive media and entertainment content or services. A user, typically patron of the restaurant, may interact with the entertainment system using an interface device 70 having a computer program allowing the access to media. Additionally, the interface device 70 may be programmed to act as an automated ordering system for food, beverages or any other service simultaneously provided to the room by one or more patron.

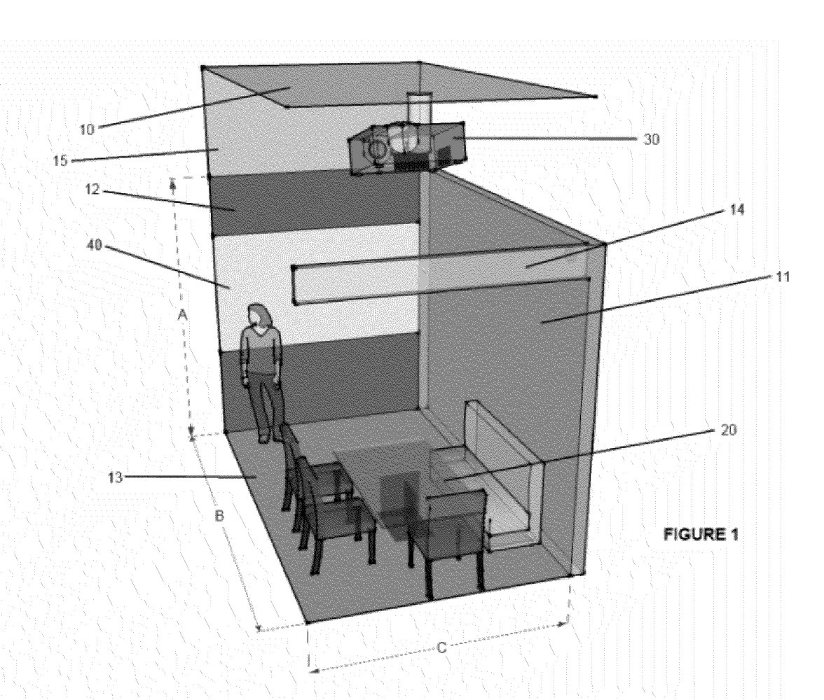

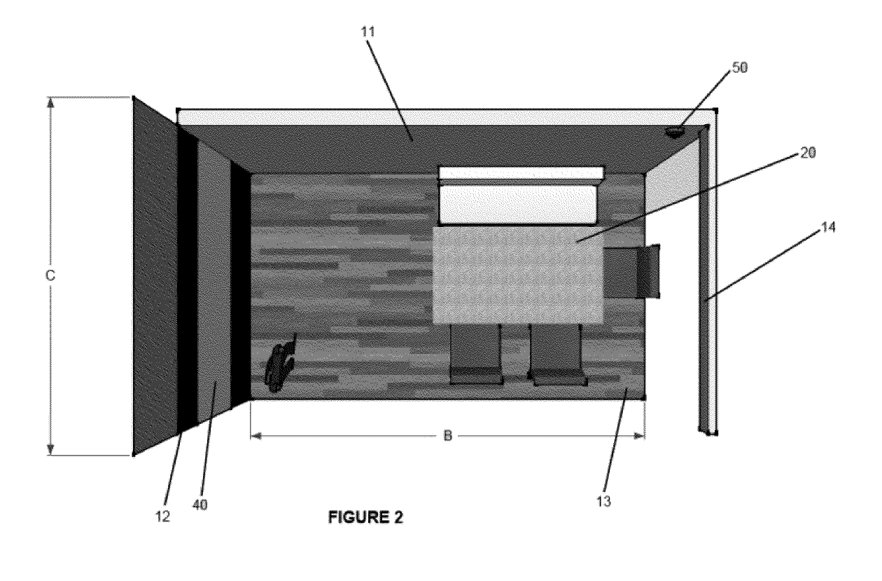

Referring to FIGS. 1, 2 and 4, in a preferred embodiment, an entertainment system for multimedia presentation may be configured within a room having at least two side walls 11 and 12, preferably a top wall or ceiling 10, a partial side wall 14 and a floor 13, a plurality of furniture elements mainly used for sitting or eating 20 and shall comprise a visual display device 25 allowing the multimedia content to be displayed, such as a projecting device 30, a projection screen 40, a television or a monitor, at least one audio system 50 (as shown in FIG. 2), a server computer 60 for processing the multimedia content, a computer network 80 and at least one interface device 70 allowing one or more user to control one or more elements of the room (not shown). In another embodiment, the wall comprises dimmable lights (not shown) which may be controlled by the patrons or may be automatically controlled by any automatic lighting system.

Still referring to FIG. 1, the dimensions of the room are identified by letters: A referring to the height of the room, B to the depth of the room and C to the width of the room. A projection screen 40 is affixed on or mounted in the side wall 12 and the projecting device 30 is downwardly affixed or attached to the ceiling 10 or one of the walls allowing the projecting device 30 to project an image or a video on the projection screen 40. A side wall extension 15 may vertically extend the side wall 12 in order to position the projecting device higher. In another embodiment, the projection screen could be replaced by a television or monitor in order to optimize the configuration of the room. The room comprises a sound system having speakers. The said speakers are typically installed on the side walls 14 or 12 but may be installed at any other location within the room to optimize the configuration or to provide better sound quality to the users. Typically, the walls shall be made of acoustic insulating material in order to prevent sound from propagating to other rooms or suite or to enter the room comprising the entertainment system or/and to provide a higher level of privacy and comfort. The plurality of furniture elements 20 may comprise at least one table, at least one chair or stool, at least one bench or any other furniture element to allow one or more person to sit or eat within the room.

In a preferred embodiment, the at least one entertainment system computer shall be located within the bench, under any furniture elements and/or on an overhanging canopy 20 in order to optimize the room configuration and to provide a spacious environment.

In other embodiments, the dimensions and shape of the room may differ from the preferred embodiment as long at the room is configured to allow a user to interact with the entertainment system.

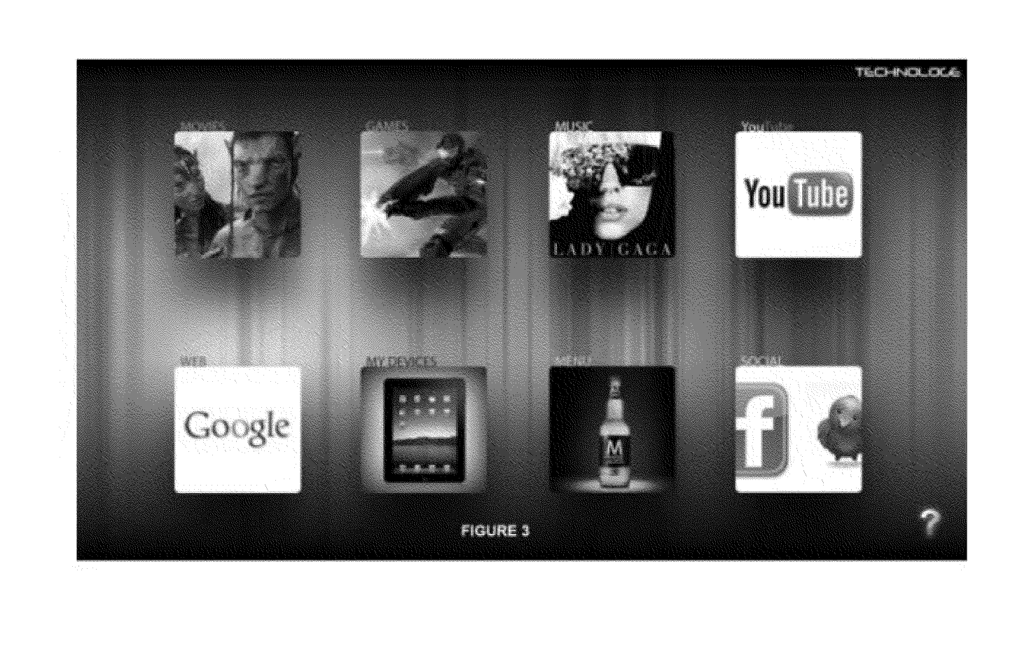

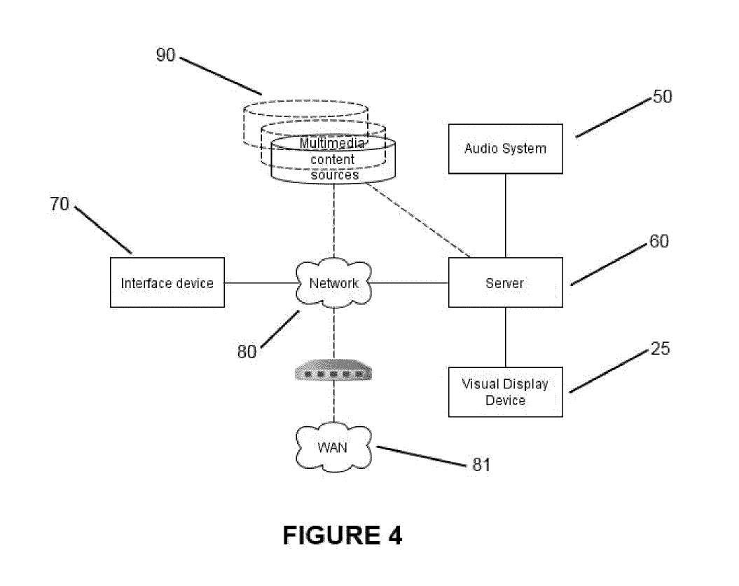

Now referring to FIG. 4, the interface device 70 communicating with the entertainment system may comprise a screen, a support, a power supply, a processing unit, a storage device, one or more input/output communication port and an inputting device allowing a person or user to control the entertainment system. The interface device 70 is typically connected to the entertainment system using any wired or wireless communication method such as internet protocols, microwave, IR, WiFi, or RF signals. In a preferred embodiment, the interface device 70 shall be embodied as a RF module remote control to communicate with the entertainment system. The at least one input/output communication port or graphical user interface may comprise a touch screen or a plurality of buttons for controlling the entertainment system. A typical menu or graphical user interface of the interface device 70 is shown in FIG. 3.

In another embodiment, the interface device 70 may be displayed on a computerized device, such as a computer, a tablet or a mobile phone, configured to execute a software application having an interface replicating the interface device. Such software application may be implemented as a mobile application, a web application or a desktop application.

In another embodiment, the inputting device 70 and the visual display device 25 may be integrated in a single device having a touch screen for a person to enter the commands to the entertainment system. In a further embodiment, the interface device 70 may be embodied as an application executed on a computing device such as, but not limited to, a computer, a tablet or a smart device such as a smart phone, a pocket pc or a netbook.

In another embodiment, the entertainment system executed a server 60 allowing the sharing or inputting of media, such a digital music, videos or both. The server 60 may be compatible with standard sharing communication protocol such as, but not limited to AirPlay, AppleConnect, any standard defined by DLNA (http://www.dlna.org).

A user wishing to stream, display, share, watch or listen to multimedia content may upload the said content through the interface device 70 or may request the streaming of dynamic or live multimedia content through the interface device 70. The interface device 70 allows the communication with the server computer 60 for processing the multimedia content and for controlling the stream, display or playing of the multimedia content through the projecting device 30, the audio system 50 or both.

In another embodiment, the user may control the entertainment system using a motion detector system, such as Microsoft Kinect™, a voice recognition system or both.

The server computer 60 comprises at least one central processing unit, physical memory, at least one storage medium and is connected to the network. Typically, the server computer 60 is configured as a server and the interface device 70 is configured as a client device. The server computer 60 comprises a computer program to be run for ordering, streaming and/or projection of the multimedia content based on the request placed through the interface device 70. Furthermore, the server computer 60 may be configured to allow a patron to automatically order any type of food, beverage or any other service provided by the restaurant or venue.

Now referring back to FIGS. 1, 2 and 4, the projecting device 30 or visual display device 25 may comprise any video, movie, image and slide projector, using any technology such as CRT, LCD or LED and may use digital or analog technology, thus allowing video content to be displayed on the projection screen 40. The projection screen 40 may be a rigid wall-mounted screen, a pull-down or electric screen or even a switchable projection screen 40. Typically, the projection screen 40 will be mounted within the side wall 12. In another embodiment, the projection screen 40 may be downwardly pulled down from the ceiling 10 or may be mobile, thus being installed anywhere within the room of the entertainment system.

In another further embodiment, the projecting device 30 and the visual display device 25 may be embodied as a television apparatus such as a flat screen television, a computer monitor or any apparatus allowing the display or projection of multimedia content.

Now referring to FIG. 4, the network 80 is configured to allow the different devices, typically the server computer 60, the interface device 70 and the visual display device 25, to communicate together and to stream multimedia content. Typically, the network 80 is a local area network providing a link to a wide area network 81 such as the Internet or an aggregation of external computer networks.

In a further embodiment, the server 60 or any other computer device connected to the network 80 may control the access to the wide area network 81, such as the Internet, in order to provide a filter against unwanted content to be downloaded or uploaded from/to the wide area network 81. Such filtering mechanism provides a control over undesirable or unsuitable content material such as pornographic content or over interface device 70 features allowing direct access to the wide area network 81, such as Internet navigation toolbar.

The entertainment system may comprise any multimedia content source 90 such as video game console system, CD/DVD or Blu-ray™ players, portable media player such as mp3 player, images, audio and video storage or streaming access, television digital or analog signals or any other internal or external source of multimedia content accessible using the network 80.

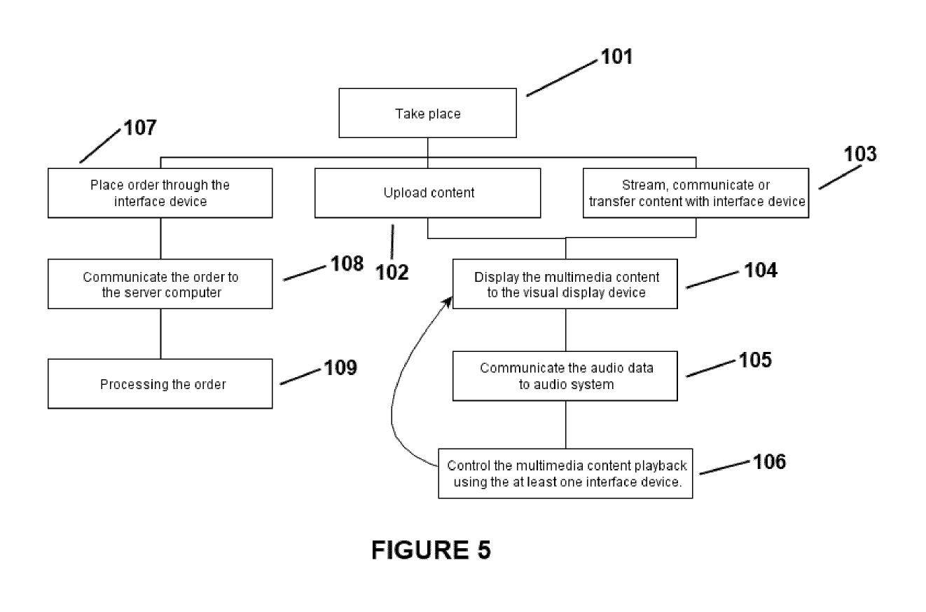

Now referring to FIG. 5, in a preferred embodiment, at least one or more person enters the room and takes place or sits at the one of the plurality of furniture elements 101. At any time, one or more person may upload 102 or use a personal device to stream, communicate or transfer multimedia content 103 through the interface device. On reception of the uploaded data or of the streaming device, the interface device allows the display of the video using the projecting device 30 and the projection screen 40 and 104 and, if the video comprises audio information, communicates the audio information or data to the audio device 50 and 105 in order to amplify the sound through the room. It should be apparent to one skilled in the art that in the event of multimedia content comprising only audio information, the visual display device, projecting device 30 and/or projection screen 40 shall be turned off and only the at least one audio device shall be turned on. At any time, one or more person located within the entertainment system room may control the multimedia content 106, such as skipping section, repeating content or stop the multimedia content.

Furthermore, at any time, a user or patron may place an order for food, beverage or any other service 107 provided by the restaurant through the interface device. The interface device communicates the order to the server computer 108 which processes the order 109.

Such system is particularly useful for use in a room designed to serve a meal and/or drinks to a private group of individuals.

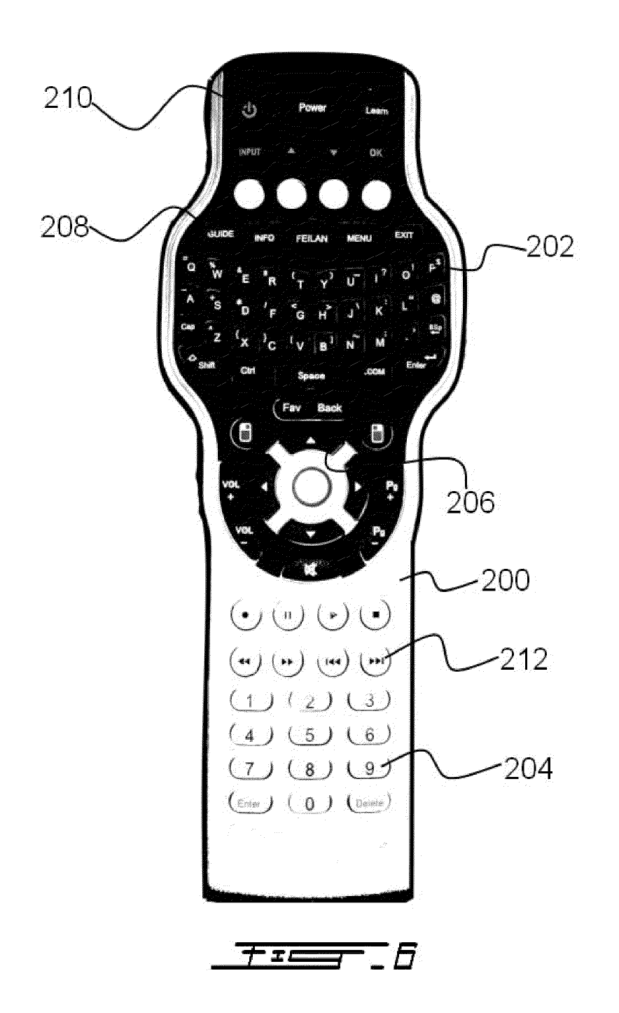

Now referring to FIG. 6, in another embodiment, the novel entertainment system for multimedia presentation in accordance with the present invention may further comprise a remote controller 200. The remote controller 200 is configured to interact with the present entertainment system and typically comprises a keyboard 202, a number pad 204, a plurality of navigation buttons 206, a power button, a general menu option 208 and playback features 212. As such, the remote controller may allow a user or a patron to fully exploit the functions of the system. Accordingly, the user or patron may, for instance, use the keyboard to navigate through the web, search music through the library or through online music provider. The remote controller 200 may interact with the entertainment system through any wired or wireless communication protocol. Typically, the remote controller 200 is configured to communicate using a radio frequencies (RF) protocol.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) An interactive entertainment system allowing at least one user to access a plurality of interactive media and entertainment content or services within a physical room of an establishment, the interactive entertainment system comprising:
a) a physical room comprising:
i) at least two walls;
ii) a ceiling;
iii) at least one element of furniture wherein each element of furniture is located within the boundaries of the physical room;
b) at least one interface device allowing the at least one user to control the entertainment system, wherein the at least one interface device comprises:
i) one or more input/output communication port;
ii) an inputting device;
c) at least one visual display device allowing multimedia content to be displayed and installed in the physical room;
d) at least one audio system installed in the physical room;
e) a server configured to process multimedia content and to communicate the multimedia content to the at least one visual display device and/or to the at least one audio system on reception of an input from the at least one interface device;
f) a network configured to interconnect the at least one interface device with the server.

2) The entertainment system of claim 1 wherein the at least one user controls the entertainment system with the interface device to display, upload, download, stream or transfer multimedia content to the visual display device and/or the visual display device.

3) The entertainment system of claim 2, wherein the entertainment system further comprises at least one multimedia content source connected to the entertainment system.

4) The entertainment system of claim 3, wherein the at least one interface device communicates with the entertainment system using a wireless communication protocol and further comprises:
a) a screen;
b) a processing unit;
c) a storage device.

5) The entertainment system of claim 4, wherein the screen is a touch screen.

6) The entertainment system of claim 5, wherein the inputting device and the screen are integrated into a single device having a touch screen for a user to enter the commands to the entertainment system.

7) The entertainment system of claim 4, wherein the interface device is a computerized device configured to execute a software application having an interface replicating the interface device.

8) The entertainment system of claim 4, wherein the wireless communication protocol is a RF based protocol.

9) The entertainment system of claim 4, wherein the at least one interface device is programmed to act as an automated ordering system for food, beverages or any other service simultaneously provided to the room by one or more patron.

10) The entertainment system of claim 1, wherein the at least two walls are made with acoustic insulating material.

11) The entertainment system of claim 10, wherein the at least two walls comprise dimmable lights.

12) The entertainment system of claim 9, wherein the server is installed under any furniture element or on an overhanging canopy.

13) The entertainment system of claim 1, wherein the at least one interface device is a motion detector system allowing the at least one user to control the entertainment system through gestures.

14) The interactive entertainment system of claim 1 wherein the visual display device comprises:
a) a projection screen;
b) at least one projecting device configured to project the multimedia content on the projection screen.

15) The interactive entertainment system of claim 1 wherein the visual display device is a television.

16) The entertainment system of claim 2, wherein a computer device connected to the network is configured to provide a filter against unwanted content to be downloaded or uploaded from/to a wide area network.

17) The entertainment system of claim 3, wherein the server comprises multimedia content sharing capabilities and is compatible with a sharing communication protocol.

18) A method for using an entertainment system, wherein the entertainment system comprises a physical room, at least one server, at least one interface device allowing the at least one user to control the entertainment system, a visual display device allowing multimedia content to be displayed, at least one audio system and a network configured to interconnect the at least one interface device with the at least one server, wherein the method comprises the steps to:
upload or use a personal device to receive, stream, communicate or transfer selected multimedia content through the at least one physical interface device;
display the multimedia content to the visual display device;
communicate the audio data to the at least one audio system;
control the multimedia content playback using the at least one interface device.

19) A method for using an entertainment system as claimed in claim 18, wherein the method further comprise the steps to:
place an order for any product or service provided to the physical room through the interface device;
communicate the order to the server computer;
process the order.

20) A method for using an entertainment system as claimed in claim 18, wherein the at least one physical interface device communicates with the entertainment system using a wireless communication protocol and further comprises:
a) one or more input/output communication port;
b) an inputting device;
c) a screen;
d) a processing unit;
e) a storage device.
